(19) United States
(12) Patent Application Publication
(10) Pub. No.: US 2007/0138121 A1
(43) Pub. Date: Jun. 21, 2007

(54) DRINKING DEVICES FOR CHILDREN WITH INTEGRATED VALVE

(75) Inventors: ROBERT P. STRIBLING, MONROE, GA (US); SAMUEL C. CROSBY, LILBURN, GA (US)

Correspondence Address: IP Authority, LLC;Ramraj Soundararajan, 9435 Lorton Market St. #801, Lorton, VA, 22079, US

(73) Assignee: THE LAST STRAW, LLC, MONROE, GA (US)

(21) Appl. No.: 11/560,778

(22) Filed: Nov. 16, 2006

Related U.S. Application Data
(60) Provisional application No. 60/597,200, filed on Nov. 16, 2005.

(51) Int. Cl. B65D 51/16; A47G 19/22; B65D 83/00; A61J 9/00

(52) U.S. Cl. 215/11.4; 215/388; 220/717; 220/714; 220/203.01

(57) ABSTRACT

A child's drinking container, e.g. sippie cup or baby bottle, uses a cover with a functionally integrated flexible cheek valve within an exiting fluid path for leakage protection. The valve is preferably a flexible check valve such as a crossbill. The valve comprises two or more flexible members that restrict the flow of fluid from a container during non-drinking situations. The flexible members of the valve limit pressurized flow and substantially prevent fluid from exiting while remaining normally closed. To open a valve section, external compressive force is applied (e.g., by a user's fingers or lips) which separates the flexible members allowing fluid to flow through, and encapsulated within a tubular drinking section having a fluid path and is attached to the exit end of the cover. An additional ventilation mechanism is added in various embodiments including a flexible air intake check valve added to the bottom of a baby bottle.

### RELATED APPLICATIONS

The present application claims priority to U.S. provisional application 60/597,200 filed Nov. 16, 2005, which is incorporated herein by reference in its entirety. Applicants' co-pending application Ser. No. 10/095,550, filed on Jan. 10, 2005, published as US 2002-0159454 A1, is also incorporated herein by reference in its entirety.

### BACKGROUND OF THE INVENTION

1. Field of Invention

The present invention is related to fluid flow control and more specifically leakage protection in child's drinking container application.

2. Discussion of Prior Art

Baby bottles and sippie cups are well known sealed drinking containers for infants or small children. The bottle typically has a nipple which is used for draining the container by compressive forces on the nipple in conjunction with suction forces. However, when the bottle is not in use, leakage may occur because of gravity, compressive forces, or worn or damaged nipple openings.

Sippie cups use various methods of reducing direct spills from an open container of drinking fluid. A cover is used, usually with a built-in mouth/lips engagement section with a limited size opening. Based on the design of the lid, various forces are minimized or used to prevent or reduce leakage. Minimizing the opening size (e.g. slit) based on liquid surface tension and drop size, a tortuous path, verterbi effects, and siphon and capillary effects are all well known applications used in various configurations. Regardless of the method used, leakage is often only minimized, but not prevented.

One problem associated with infant/children drinking devices is the forced evacuation of fluid through squeezing of the container or by vacuum related capillary action. Tipping of the container may also cause fluid spills. The present invention reduces or eliminates the unwanted draining of the container.

Whatever the precise merits, features, and advantages of the prior art, it does not achieve or fulfill the purposes of the present invention.

### SUMMARY OF THE INVENTION

The present invention uses a cover with a functionally integrated flexible check valve within an exiting fluid path for leakage protection. The valve is preferably a flexible check valve such as a crossbill. The valve comprises two or more flexible members that restrict the flow of fluid from a container during non-drinking situations. The flexible members of the valve limit pressurized flow and substantially prevent fluid from exiting while remaining normally closed. To open a valve section, external compressive force is applied (e.g., by a user's fingers or lips) which separates the flexible members allowing fluid to flow through. When external compressive force is no longer applied to the valve section, the valve returns to its normally closed position and fluid is prevented from exiting. Pressurized forces, such as fluid trying to escape through the valve when a user squeezes the drinking container, or when the container is held in an upside down position only serve to press the flexible members together with greater force.

The flexible check valve is preferably silicone and encapsulated within a tubular drinking section having a fluid path and is attached to the exit end of the cover. The attachment and flexible members of the valve may comprise several embodiments.

### BRIEF DESCRTPTION OF THE DRAWINGS

FIG. 1a illustrates a top view of a retro-fit sippie cup lid embodiment of the present invention.

FIG. 1b illustrates a side view of a retro-fit sippie cup lid embodiment of the present invention.

FIG. 1c illustrates a bottom view of a retro-fit sippie cup lid embodiment of the present invention.

FIG. 1d illustrates a cross-section A-A of the retro-fit sippie cup lid embodiment of FIG. 1b.

FIG. 1e illustrates the detail of cross-section A-A.

FIG. 1f illustrates a perspective view of the present invention retro-fit sippie cup lid embodiment.

FIG. 2a illustrates a top view of a sippie cup embodiment of the present invention.

FIG. 2b illustrates a side view of a sippie cup embodiment of the present invention.

FIG. 2c illustrates a bottom view cross-section of the sippie cup of FIG. 2b.

FIG. 2d illustrates a side view cross-section B-B of the sippie cup embodiment of FIG. 2b.

FIG. 2e illustrates the detail of cross-section B-B.

FIG. 2f illustrates a perspective view of the present invention sippie cup embodiment.

FIG. 3a illustrates a top view of a baby bottle embodiment of the present invention.

FIG. 3b illustrates a side view of a baby bottle embodiment of the present invention.

FIG. 3c illustrates a bottom view of a baby bottle embodiment of the present invention.

FIG. 3d illustrates a cut-away side view of the present invention baby bottle of FIG. 3b.

FIG. 3e illustrates an enlarged cut-away side view as shown in FIG. 3d.

FIG. 3f illustrates a perspective view of the baby bottle of the present invention.

FIGS. 4a and 4b, each illustrate exploded views of the baby bottle embodiment of the present invention as shown in FIG. 3b.

FIG. 5a illustrates a top view of an alternative baby bottle embodiment of the present invention with air intake valve.

FIG. 5b illustrates a side view of an alternative baby bottle embodiment of the present invention with air intake valve.

FIG. 5c illustrates a bottom view of alternative baby bottle embodiment of the present invention with air intake valve.

FIG. 5d illustrates a cut-away side view of alternative baby bottle embodiment of the present invention with air intake valve as shown in FIG. 3b.

FIG. 5e illustrates a detailed view of the air intake valve as shown in FIG. 5d.

FIG. 5f illustrates a detailed view of the top silicone valve seating area shown in FIG. 5d.

FIG. 5g illustrates a perspective view of the alternative baby bottle embodiment of the present invention with air intake valve.

FIGS. 6a and 6b, each illustrate exploded views of the alternative baby bottle embodiment of the present invention with air intake valve as shown in FIG. 5b.

### DESCRIPTION OF THE PREFERRED EMBODIMENTS

While this invention is illustrated and described in a preferred embodiment, the device may be produced in many different configurations, forms and materials. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention. In the description below it should be noted that the term “fluid” should include any type of liquid, gas, powder, particulate, gel, or colloid. Specific fluids of interest for use in the preferred embodiments include milk, baby formula, baby cereal mixtures, juices, and water, but should not be limited thereto.

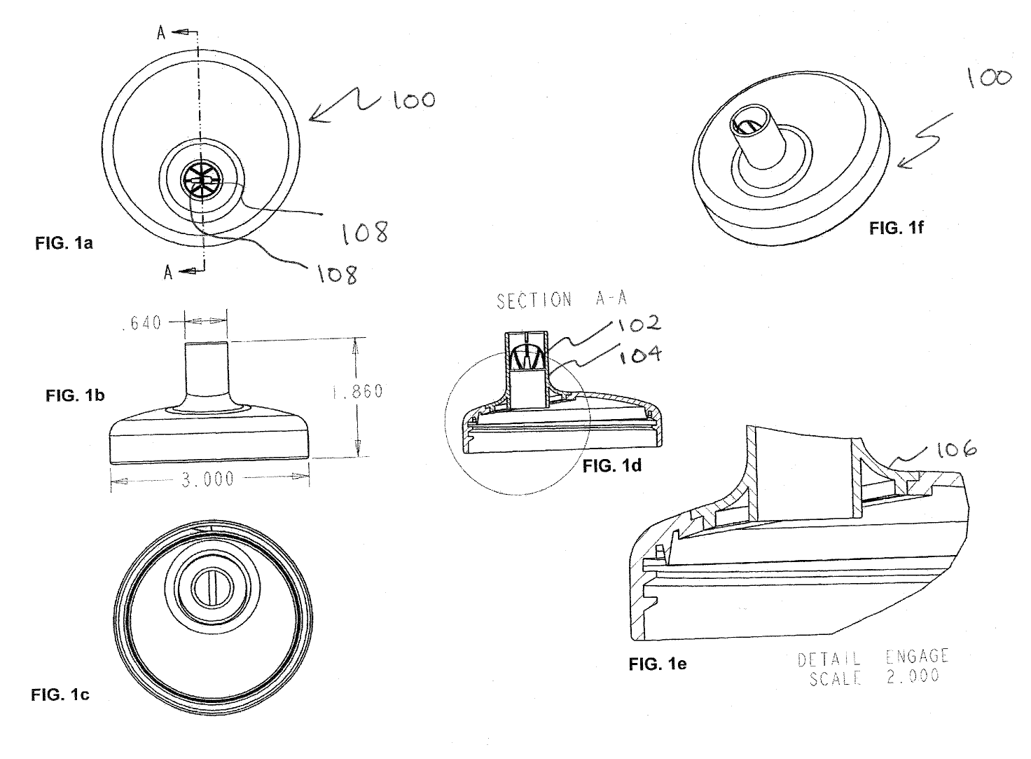

A child's drinking container lid 100 (e.g. sippie cup lid) with leakage protection is shown in a first embodiment in FIGS. 1a-1f. These figures illustrate a retro-fit sippie cup lid. Instead of using an existing sippie-cup lid, the lid is removed and replaced, before or after distribution, with the present invention lid. The present invention lid 100 includes a flexible check valve 102 (as fully described in Applicants' commonly-owned U.S. publication number 2002-0159454 A1), preferably made of silicone (overmolded), contained within a flexible tube 104 integrated within the lid (e.g. injection molded polycarbonate) by retention of base section 106 (circumferentially extending). The flexible valve preferably is a crossbill (shown) with operatively joined multiple flexible flaps and orientated away from the fluid exit direction. However, a similarly configured duckbill or functional equivalent is within the scope of the present invention. The valve may, in some embodiments, include lobes 108 which assist in opening flaps of the valve by pressing against each other during actuation by the user.

In use, a user would open the valve (actuate) with minimal pressure on the flexible tube 104 using lips or teeth and drain the fluid using normal drinking techniques. When the valve is not actuated, the valve remains in a normally closed position and will not leak regardless of orientation. The tube with valve is removable for cleaning or replacement purposes, but it would not be outside the scope of the present invention to be permanently integrated such as by overmolding or other equivalent attachment methods (e.g. adhesives).

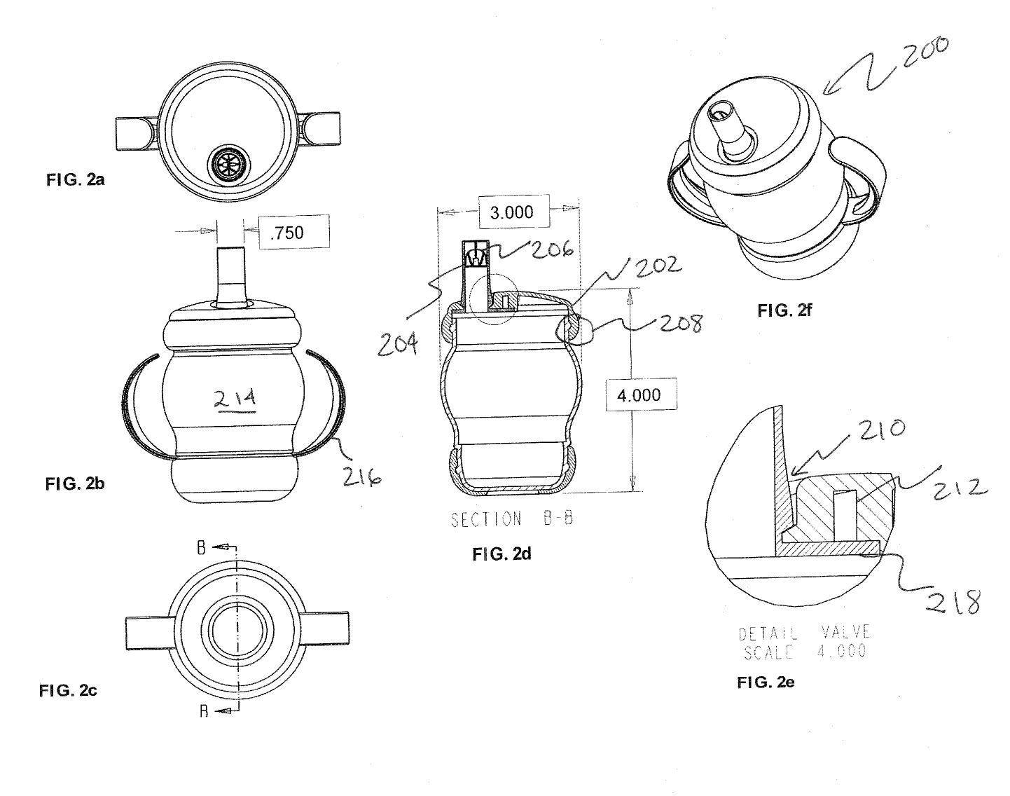

A children's drinking container (e.g. sippie cup) with leakage protection is shown in a second embodiment in FIGS. 2a-2f. These figures illustrate a sippie cup. Instead of using a traditional sippie-cup lid, the present invention lid 202 (e.g. injection molded polycarbonate) includes a removable tube 204 encapsulating a crossbill flexible check valve 206, preferably made of silicone (overmolded). The lid is attached as shown using a detent and rib snap fit 208, but other known methods of attachment can be used (e.g. threaded). A user would open the cover insert the valve tube through an opening in the cup 210 and reattach the cover. The flexible tube base 218 (circumferentially extending) would be retained between the cup 214 and the lid 202. A ventilation mechanism 212 is shown in FIG. 2e to equalize the pressure so that fluid can escape. The user would open the valve (actuate) with minimal pressure using lips or teeth and drain the fluid using normal drinking techniques. When the valve is not actuated, the valve remains in a normally closed position and will not leak regardless of orientation. The valve is preferably removable for cleaning or replacement purposes, but also could be permanently integrated. Secondary features may include an ergonomically shaped cup 214 and integrated handle 216.

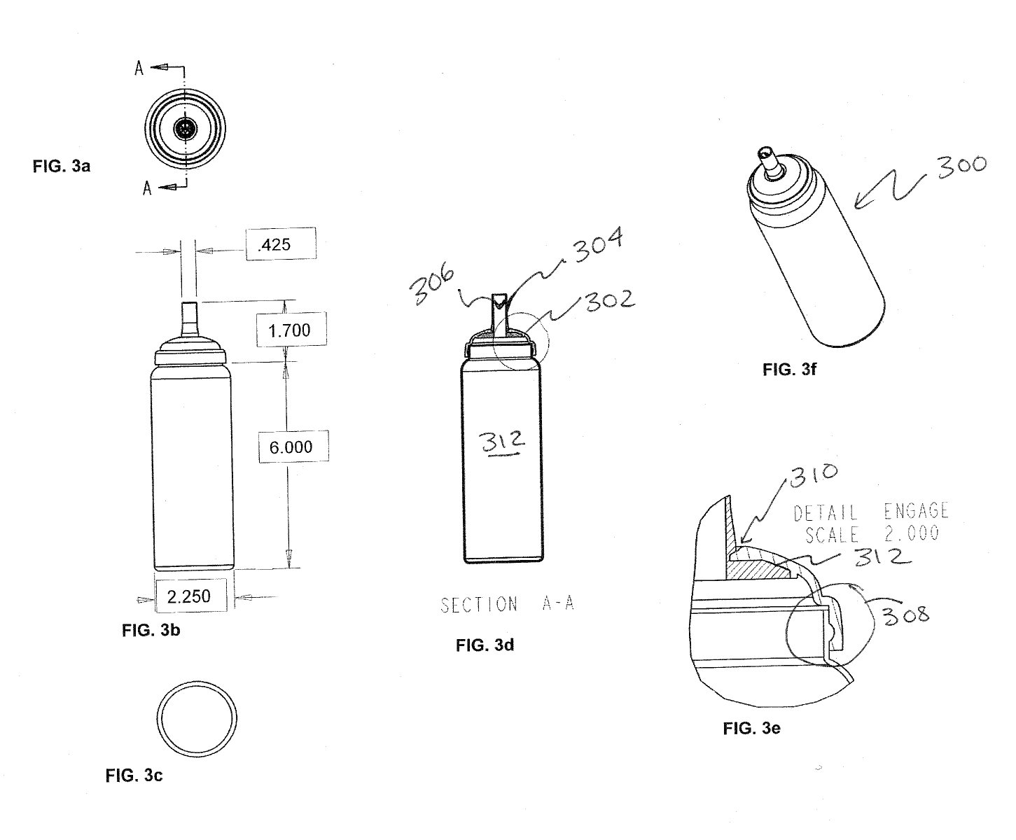

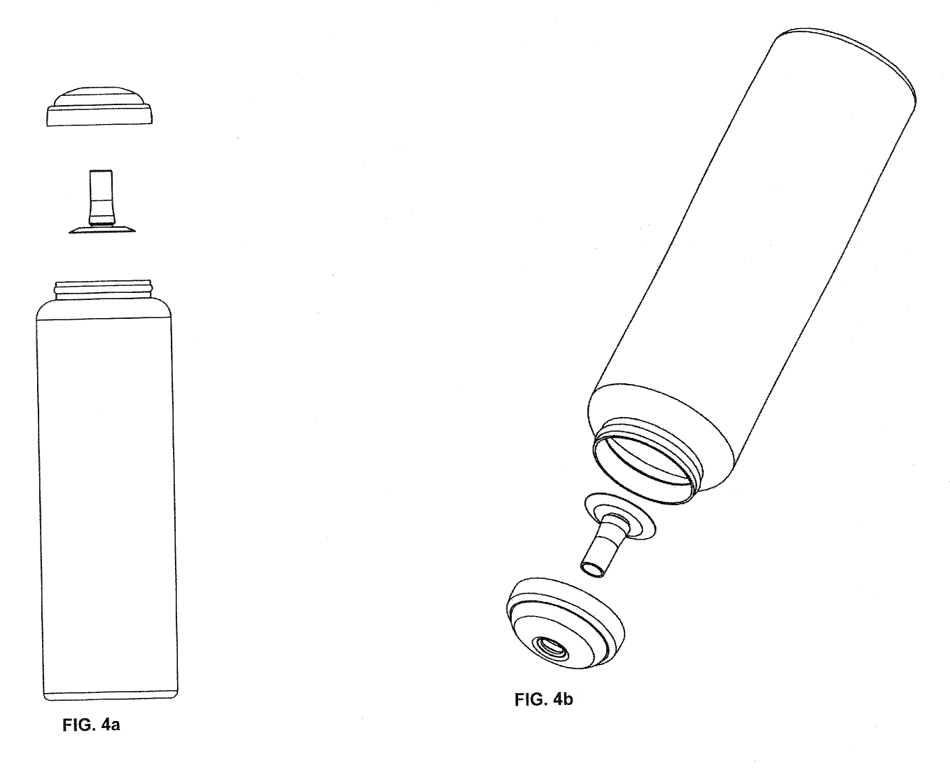

FIGS. 3a-4b collectively illustrate a baby bottle 300 embodiment of the present invention. Instead of using a traditional nipple, the present invention lid 302 (e.g. polypropylene) includes a removable tube 304 encapsulating a crossbill flexible check valve 306, preferably made of silicone (injection molded). The lid is attached as shown to a bottle (polycarbonate blow molded) using a detent and rib snap fit 308, but other known methods of attachment can be used (e.g. threaded). A user would open the cover insert the valve tube 304 (snap fit) through opening 310 and reattach the cover (also shown in FIGS. 4a and 4b). The flexible tube's base 312 (circumferentially extending) would be retained by the lid 302. The user would open the valve (actuate) with minimal pressure using lips or teeth and drain the fluid using normal drinking techniques. When the valve is not actuated, the valve remains in a normally closed position and will not leak regardless of orientation. The valve is preferably removable for cleaning or replacement purposes, but could be integrated.

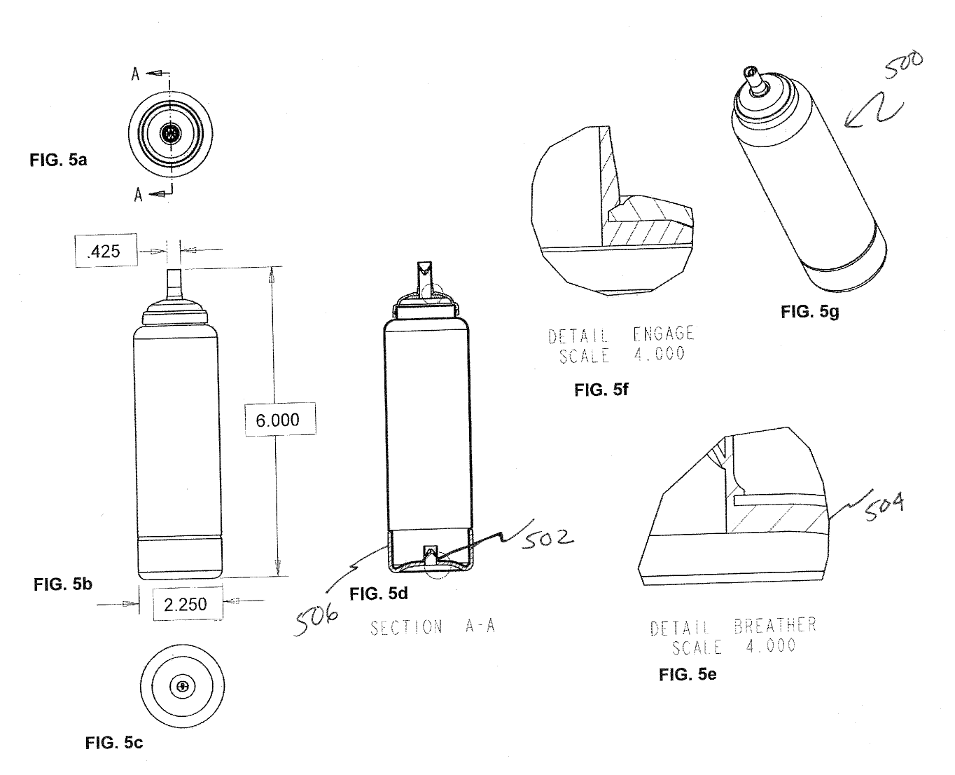

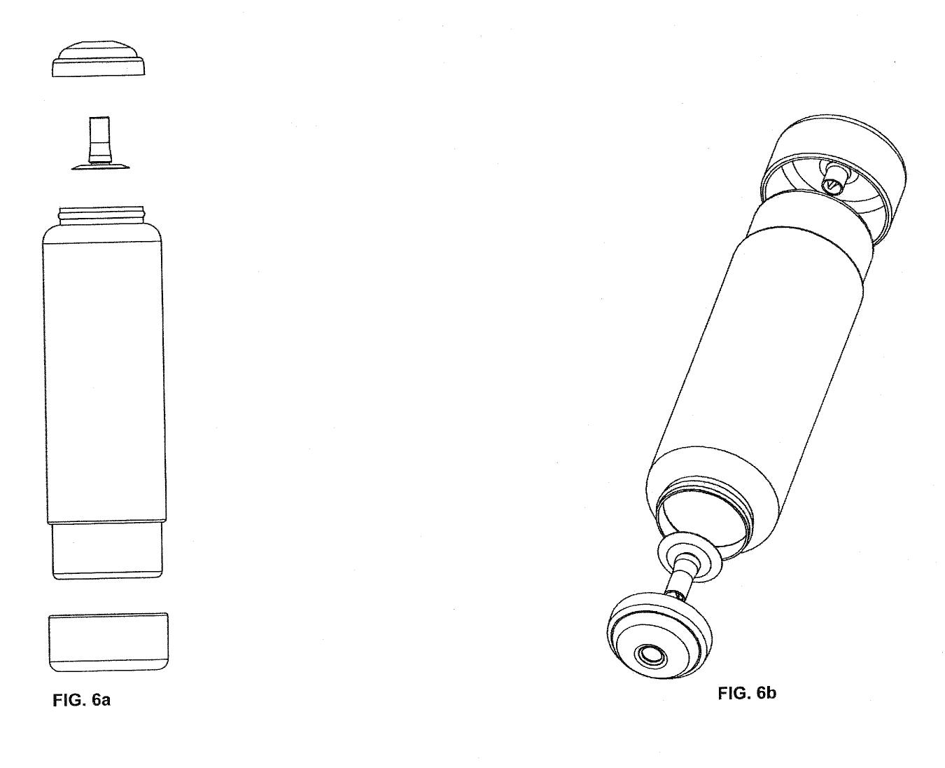

FIGS. 5a-6b illustrate an alternative baby bottle 500 embodiment modifying the embodiment shown in FIGS. 3a-4b with an air intake valve 502 removably located at the bottom of the bottle to allow equalization of pressure, i.e. air enters from the bottom as fluid exits the top. Base 504 (circumferentially extending) retains the valve within the removable section 506. The air intake valve is similar in construction to the drinking valve (oriented in opposite direction) and provides a leakage check for fluid within the container. The valve is removable by detaching section for cleaning or replacement purposes (FIGS. 6a and 6b).

### CONCLUSION

A system and method has been shown in the above embodiments for the effective implementation of a valve for a children's drinking container. While various preferred embodiments have been shown and described, it will be understood that there is no intent to limit the invention by such disclosure, but rather, it is intended to cover all modifications and alternate constructions falling within the spirit and scope of the invention. For example, the present invention should not be limited by size, materials, or specific manufacturing techniques.

In addition, the flexible check valve structure, manufacturing and attachment techniques (e.g. overmolding) can be used to prevent pressurized loss/retention of any liquid, gas, powder, particulate, gel, or colloid. Specific attachment methods shown in the drawings can be used with other flexible check valves without departing from the scope of the invention.

Specific fluids of interest in the preferred embodiments include milk, formula, baby cereal mixtures, juices, and water, but should not be limited thereto. The apparatus can be equally applied to alternative fields such as medical. The completeness of leakage prevention may be based on the quality of materials, manufacturing techniques, attachment techniques, and pressures encountered. In any embodiment, the configuration should substantially prevent fluids from escaping past the flexible check valve and ideally provide a 100% check.

What is claimed is:

1. A removably secured drinking tube with leakage protection, said drinking tube comprising:
a drinking section, said drinking section having a proximate and distal end, said distal end used as an exit for fluids;
a functionally integrated flexible check valve encapsulated within said drinking section, said flexible check valve comprising two or more flexible members oriented in a direction opposite said distal end that are pressed together in a normally closed configuration and under fluid pressure, during non-drinking situations, restrict the flow of fluid from said distal end;
a base section formed at said proximate end of said drinking section and comprising a circumferentially extending section, and
wherein said circumferentially extending section is used in association with a drinking container and cap for secured retention thereto.

2. A removably secured drinking tube with leakage protection as per claim 1, wherein said drinking tube comprises a baby bottle nipple.

3. A removably secured drinking tube with leakage protection as per claim 1, wherein said drinking tube comprises a sippie cup nipple.

4. A removably secured drinking tube with leakage protection as per claim 1, wherein said flexible check valve is a crossbill.

5. A removably secured drinking tube with leakage protection as per claim 1, wherein said flexible check valve is a duckbill.

6. A removably secured drinking tube with leakage protection as per claim 1, wherein said flexible check valve comprises a silicone material.

7. A removably secured sippie cup nipple with leakage protection, said sippie cup nipple removably secured to a sippie cup during use, said sippie cup nipple comprising:
a drinking section, said drinking section having a proximate and distal end, said distal end used as an exit for fluids;
a functionally integrated flexible check valve encapsulated within said drinking section, said flexible check valve comprising two or more flexible members oriented in a direction opposite said distal end that are pressed together in a normally closed configuration and under fluid pressure, during non-drinking situations, restrict the flow of fluid from said distal end;
a base section formed at said proximate end of said drinking section and comprising a circumferentially extending section, and
wherein said circumferentially extending section is operative with said sippie cup and a cap for secured retention thereto.

8. A removably secured sippie cup nipple as per claim 7, wherein said flexible check valve is a crossbill.

9. A removably secured sippie cup nipple as per claim 7, wherein said flexible check valve is a duckbill.

10. A removably secured sippie cup nipple as per claim 7, wherein said flexible check valve comprises a silicone material.

11. A removably secured baby bottle nipple with leakage protection, said baby bottle nipple removably secured to a baby bottle during use, said nipple comprising:
a drinking section, said drinking section having a proximate and distal end, said distal end used as an exit for fluids;
a functionally integrated flexible check valve encapsulated within said drinking section, said flexible check valve comprising two or more flexible members oriented in a direction opposite said distal end that are pressed together in a normally closed configuration and under fluid pressure during non-drinking situations restrict the flow of fluid from said distal end;
a base section integrated at said proximate end of said drinking section and comprising a circumferentially extending section, and
wherein said circumferentially extending section is used in association with a baby bottle and cap for secured retention thereto.

12. A removably secured baby bottle nipple as per claim 11, wherein said flexible check valve is a crossbill.

13. A removably secured baby bottle nipple as per claim 11, wherein said flexible check valve is a duckbill.

14. A removably secured baby bottle nipple as per claim 11, wherein said flexible check valve is a silicone material.

15. A baby bottle with leakage protection, said baby bottle comprising:
a fluid container;
a nipple comprising a drinking section, said drinking section having a proximate and distal end, said distal end used as an exit for fluids;
a functionally integrated flexible check valve encapsulated within said drinking section, said flexible check valve comprising two or more flexible members oriented in a direction opposite said distal end that are pressed together in a normally closed configuration and under fluid pressure during non-drinking situations restrict the flow of fluid from said distal end;
a base section integrated at said proximate end of said drinking section and comprising a circumferentially extending section,
a removable cap with opening to receive said nipple, and
wherein said removable cap secures said circumferentially extending section to said fluid container.

16. A baby bottle as per claim 15, wherein said flexible check valve is a crossbill.

17. A baby bottle as per claim 15, wherein said flexible check valve is a duckbill.

18. A baby bottle as per claim 15, wherein said flexible check valve is a silicone material.

19. A baby bottle as per claim 15, further comprising a ventilation mechanism.

20. A baby bottle as per claim 16, wherein said ventilation mechanism comprises a second removable flexible check valve secured to a bottom of said fluid container.

21. A sippie cup with leakage protection, said sippie cup comprising:
a fluid container;
a nipple comprising a drinking section, said drinking section having a proximate and distal end, said distal end used as an exit for fluids;
a functionally integrated flexible check valve encapsulated within said drinking section, said flexible check valve comprising two or more flexible members oriented in a direction opposite said distal end that are pressed together in a normally closed configuration and under fluid pressure, during non-drinking situations, restrict the flow of fluid from said distal end;
a base section formed at said proximate end of said drinking section and comprising a circumferentially extending section;
a removable cap with opening for said nipple, and
wherein said removable cap operatively secures said circumferentially extending section to said fluid container.

22. A sippie cup as per claim 21, wherein said flexible check valve is a crossbill.

23. A sippie cup as per claim 21, wherein said flexible check valve is a duckbill.

24. A sippie cup as per claim 21, wherein said flexible check valve is a silicone material.

25. A sippie cup as per claim 21, wherein said flexible check valve is overmolded onto said removable cap.
